(19) United States
(12) Patent Application Publication
(10) Pub. No.: US 2026/0021407 A1
(43) Pub. Date: Jan. 22, 2026

(54) METHOD AND APPARATUS FOR EDITING VIRTUAL ELEMENT, DEVICE, MEDIUM, AND PRODUCT

(71) Applicant: Tencent Technology (Shenzhen) Company Limited, Shenzhen (CN)

(72) Inventors: Gongxian CAI, Shenzhen (CN); Yahan CHEN, Shenzhen (CN); Zhenhua ZHU, Shenzhen (CN); Yang HU, Shenzhen (CN)

(73) Assignee: Tencent Technology (Shenzhen) Company Limited, Shenzhen (CN)

(21) Appl. No.: 19/345,704

(22) Filed: Sep. 30, 2025

Related U.S. Application Data
(63) Continuation of application No. PCT/CN2024/108856, filed on Jul. 31, 2024.

(30) Foreign Application Priority Data
Nov. 17, 2023 (CN) 202311545552.6

(51) Int. Cl. A63F 13/63; G06T 19/20

(52) U.S. Cl. CPC A63F 13/63; G06T 19/20

(57) ABSTRACT

The present disclosure discloses a method and apparatus for editing a virtual element, a device, a medium, and a product, relating to the field of internet technologies. The method includes the following operations: displaying a first virtual element in a virtual scene, the first virtual element being a user generated content (UGC) object (410); displaying a mirroring coordinate system in response to receiving a mirroring trigger operation for the first virtual element, the mirroring coordinate system including a plurality of mirroring coordinate axes forming at least two mirroring axial planes (420); displaying, in response to receiving a trigger operation for a first mirroring axial plane of the at least two mirroring axial planes, a mirroring result of the first virtual element with the first mirroring axial plane as a flipping reference plane (430).

### RELATED APPLICATION

The present disclosure is a continuation of and claims the benefit of priority to PCT Application No. PCT/CN2024/108856, filed Jul. 31, 2024, and entitled VIRTUAL ELEMENT EDITING METHOD AND APPARATUS, DEVICE, MEDIUM, AND PRODUCT, which is based on and claims the benefit of priority to Chinese Patent Application No. 202311545552.6, entitled “METHOD AND APPARATUS FOR EDITING VIRTUAL ELEMENT, DEVICE, MEDIUM, AND PRODUCT” filed on Nov. 17, 2023. The above applications are incorporated herein by reference in their entireties.

### FIELD OF THE TECHNOLOGY

Embodiments of the present disclosure relate to the field of computer technologies, and in particular, to a method and apparatus for editing a virtual element, a device, a medium, and a product.

### BACKGROUND OF THE DISCLOSURE

User generated content (UGC) refers to self-created content shared by users on the Internet. In the field of games, a designer encourages users to participate in the design of game content such as level maps, gameplay, and ecosystem by providing a corresponding UGC editing feature in a game. A three-dimensional object is a common UGC.

In the related art, a player may manually perform operations such as rotation and translation on a plurality of identical three-dimensional objects, presenting a mirror effect among the three-dimensional objects, so as to enrich object structures. However, the above-mentioned manner can achieve the mirror effect of the three-dimensional objects only if the player has strong spatial imagination ability, and thus has a high barrier for operation.

### SUMMARY

The embodiments of the present disclosure provide a method and apparatus for editing a virtual element, a device, a medium, and a product. The technical solutions are as follows:

In an aspect, provided is a method for editing a virtual element in a virtual scene, performed by a computer device and including:
displaying a first virtual element in a virtual scene;
displaying a mirroring coordinate system in response to receiving a mirroring trigger operation for the first virtual element, the mirroring coordinate system including a plurality of mirroring coordinate axes, and the plurality of mirroring coordinate axes forming at least two mirroring axial planes which are configured for simulating a mirror surface to mirror the first virtual element; and
displaying a mirroring result of the first virtual element based on a first mirroring axial plane in response to receiving a trigger operation for the first mirroring axial plane of the at least two mirroring axial planes.

In another aspect, provided is an apparatus for editing a virtual element in a virtual scene, including:
an object display module configured to display a first virtual element in a virtual scene;
a coordinate system display module configured to display a mirroring coordinate system in response to receiving a mirroring trigger operation for the first virtual element, the mirroring coordinate system including a plurality of mirroring coordinate axes, and the plurality of mirroring coordinate axes forming at least two mirroring axial planes which are configured for simulating a mirror surface to mirror the first virtual element; and
a mirroring result display module configured to display a mirroring result of the first virtual element based on a first mirroring axial plane in response to receiving a trigger operation for the first mirroring axial plane of the at least two mirroring axial planes. In another aspect, provided is a computer device, including a processor and a memory, the memory having at least one instruction, at least one program, a code set, or an instruction set stored therein which is loaded and executed by the processor to implement the method for editing a virtual element in a virtual scene according to any one of the foregoing embodiments of the present disclosure.

In another aspect, provided is a computer-readable storage medium, having at least one instruction, at least one program, a code set, or an instruction set stored therein which is loaded and executed by the processor to implement the method for editing a virtual element in a virtual scene according to any one of the foregoing embodiments of the present disclosure.

In another aspect, provided is a computer program product or a computer program, including computer instructions stored in a computer-readable storage medium. A processor of a computer device reads the computer instructions from the computer-readable storage medium and executes the computer instructions to cause the computer device to perform the method for editing a virtual element in a virtual scene according to any one of the foregoing embodiments.

The technical solutions provided in the embodiments of the present disclosure produce at least the following beneficial effects:

By receiving the mirroring trigger operation for the first virtual element (a UGC object), the mirroring coordinate system is displayed. A plurality of mirroring axial planes in the mirroring coordinate system can provide flipping reference planes for mirroring the first virtual element, thereby improving convenience when a user edits the first virtual element. By receiving the trigger operation for the mirroring axial plane, the mirroring result of the first virtual element after flipping based on a mirroring axial plane can be automatically displayed, so that the structure presentation effect of the first virtual element is clearer and more visual, thereby improving the efficiency of designing the structure of the first virtual element by the user.

### BRIEF DESCRIPTION OF THE DRAWINGS

FIG. 1 is an example schematic diagram of displaying a mirroring coordinate system in a virtual scene provided by one exemplary embodiment of the present disclosure.

FIG. 2 is an example structural block diagram of an electronic device provided by one exemplary embodiment of the present disclosure.

FIG. 3 is an example block diagram of a computer system provided by one exemplary embodiment of the present disclosure.

FIG. 4 is an example flowchart of a method for editing a virtual element in a virtual scene provided by one exemplary embodiment of the present disclosure.

FIG. 5 is an example schematic diagram of an editing function option provided by one exemplary embodiment of the present disclosure.

FIG. 6 is an example schematic diagram of an editing function option following a first virtual element provided by one exemplary embodiment of the present disclosure.

FIG. 7 is an example schematic diagram of a process of triggering a mirroring function option provided by one exemplary embodiment of the present disclosure.

FIG. 8 is an example schematic diagram of a process of selecting a target mirroring option provided by one exemplary embodiment of the present disclosure.

FIG. 9 is an example schematic diagram of center-based mirroring on a first virtual element provided by one exemplary embodiment of the present disclosure.

FIG. 10 is an example schematic diagram of flush mirroring on a first virtual element provided by one exemplary embodiment of the present disclosure.

FIG. 11 is an example flowchart of a method for editing a plurality of first virtual elements provided by one exemplary embodiment of the present disclosure.

FIG. 12 is an example schematic diagram of selecting a plurality of first virtual elements provided by one exemplary embodiment of the present disclosure.

FIG. 13 is an example schematic diagram of center-based mirroring on a virtual module corresponding to first virtual elements provided by one exemplary embodiment of the present disclosure.

FIG. 14 is an example schematic diagram of flush mirroring on a virtual module corresponding to first virtual elements provided by one exemplary embodiment of the present disclosure.

FIG. 15 is an example flowchart of a method for simultaneously mirroring and copying a first virtual element provided by one exemplary embodiment of the present disclosure.

FIG. 16 is an example schematic diagram of triggering copying of a first virtual element provided by one exemplary embodiment of the present disclosure.

FIG. 17 is an example structural block diagram of an apparatus for editing a virtual element in a virtual scene provided by one exemplary embodiment of the present disclosure.

FIG. 18 is an example structural block diagram of an apparatus for editing a virtual element in a virtual scene provided by another exemplary embodiment of the present disclosure.

FIG. 19 is an example structural block diagram of a computer device according to an exemplary embodiment of the present disclosure.

### DESCRIPTION OF EMBODIMENTS

Terms involved in the embodiments of the present disclosure are briefly introduced below.

User generated content (UGC): it is original content created by a user. Users present, or provide to other users, their original content via an Internet platform.

In a game application program or a virtual scene based application program, some necessary mechanisms and the corresponding UGC editing feature are provided in the application program to encourage users to participate in the design of game content such as level maps, gameplay, and ecosystem, thus increasing interest in a game process.

In a game application program or some virtual scene based application programs, a player usually can control a virtual object in a virtual scene, or edit a virtual object in a virtual scene, for example, alter a form, an appearance, or a number of virtual elements, control a virtual element to perform motion; or create a virtual element by using a function provided by the application programs.

Exemplarily, the player can edit an editable virtual element to implement a combination of virtual elements.

In one embodiment, the editable virtual element includes a first virtual element. The player may alter the form of the first virtual element by performing an editing operation such as moving, rotating, or scaling on the editable virtual element. When the editable virtual element further includes a second virtual element, the player may further combine the first virtual element and the second virtual element into a virtual module. Alternatively, the player may construct a virtual module with a symmetrical structure by altering orientation of virtual elements, etc.

In some virtual scene based application programs, a virtual element is a three-dimensional virtual element. The structure of a three-dimensional virtual element is richer and more complex than that of a two-dimensional virtual element. When a player edits a three-dimensional virtual element, the player cannot accurately obtain a virtual element with a complex structure only through simple operations such as translation and rotation.

For a user using a mobile phone terminal, it is difficult to edit a structure of a three-dimensional element by using a script editor. Furthermore, in a manner of writing a code script, a user needs to have a programming basis and strong spatial imagination ability. This manner presents a high barrier for operation by a player and difficulties in an operation process, and thus cannot be normally used by most players.

The present disclosure provides a method for editing a virtual element in a virtual scene, which may be operated on a terminal installed with a virtual scene based application program. With a function for editing a virtual element preset in the application program, by triggering a corresponding control, a virtual element may be controlled to perform complex motions such as rotation, three-dimensional mirroring, and translation, so that a player fully learns the structure of the virtual element, and implements operations such as editing, combining, designing, and copying on the virtual element. Taking a mirroring function as an example, when the mirroring function for a specified virtual element in a virtual scene is triggered, a mirroring coordinate system corresponding to the specified virtual element is displayed. An origin of the mirroring coordinate system is a preset reference point on the specified virtual element. The mirroring coordinate system includes a plurality of mirroring coordinate axes forming at least two mirroring axial planes. The mirroring axial plane is configured for providing a flipping reference plane for mirroring virtual elements. A user may mirror a specified virtual element according to the mirroring axial plane to obtain a highly symmetrical virtual element without manually controlling flipping of the virtual element. Therefore, when a structure of a virtual element is designed, the operation efficiency and the precision of a flipping operation are improved.

Exemplarily, FIG. 1 is a schematic diagram of displaying a mirroring coordinate system in a virtual scene. A selected specified virtual element 110 is present in the virtual scene 100, and after a mirroring trigger operation for the specified virtual element 110 is received, the mirroring coordinate system 120 is displayed correspondingly. In one embodiment, an origin of the mirroring coordinate system 120 is a center of the specified virtual element 110. The mirroring coordinate system 100 includes a plurality of mirroring coordinate axes 121 and a plurality of mirroring axial planes 122 formed by the plurality of mirroring coordinate axes 121.

By triggering any one of the plurality of mirroring axial planes 122, a mirroring result of the specified virtual element 110 with the mirroring axial plane 122 as a flipping reference plane is displayed correspondingly.

The number and locations of the mirroring coordinate axes included in the mirroring coordinate system may be arbitrary. Description with reference to FIG. 1 is made by taking three mirroring axial planes as an example. In some embodiments, the locations and number of the mirroring axial planes in the mirroring coordinate system may be arbitrary.

A terminal in the present disclosure may be a desktop computer, a laptop computer, a mobile phone, a tablet computer, an e-book reader, a moving picture experts group audio layer III (MP3) player, a moving picture experts group audio layer IV (MP4) player, or the like. The terminal has installed and run thereon an application program supporting a virtual scene, e.g., an application program supporting a three-dimensional virtual scene. The application program may be any one of a virtual reality application program, a three-dimensional map program, a simulation game (SLG), a multiplayer online battle arena (MOBA) game, and the like. In one embodiment, the application program may be a standalone application program, such as a standalone three-dimensional game program, or may be a network-connected application program.

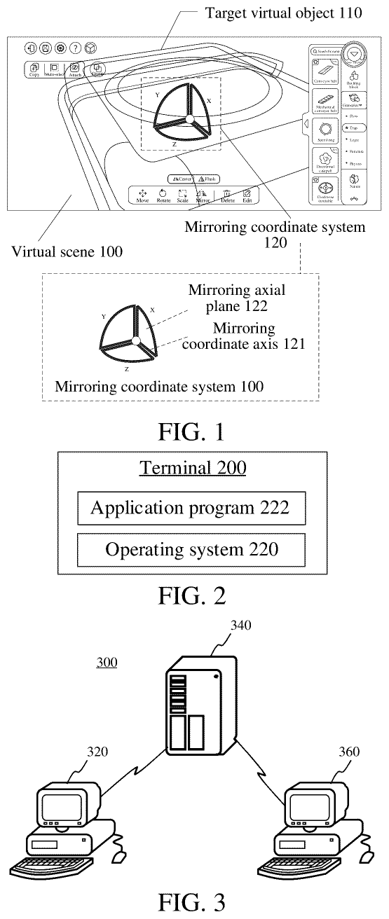

FIG. 2 is a structural block diagram of an electronic device according to an exemplary embodiment of the present disclosure. An electronic device 200 includes an operating system 220 and an application program 222. The operating system 220 is basic software provided for the application program 222 to perform secure access to computer hardware. The application program 222 is an application program supporting a virtual scene. In one embodiment, the application program 222 is an application program supporting a three-dimensional virtual scene. The application program 222 may be any one of a virtual reality application program, a three-dimensional map program, a third-person shooting (TPS) game, a first-person shooting (FPS) game, an MOBA game, an SLG. The application program 222 may be a standalone application program, such as a standalone three-dimensional game program; or may be a network-connected application program.

FIG. 3 illustrates a structural block diagram of a computer system provided by one exemplary embodiment of the present disclosure. A computer system 300 includes a first device 320, a server 340, and a second device 360. The first device 320 has installed and run thereon an application program supporting a virtual scene. The application program may be any one of a virtual reality application program, a three-dimensional map program, a TPS game, an FPS game, an MOBA game, and an SLG. The first device 320 is a device used by a first user. The first user uses the first device 320 to control a main control virtual object in the virtual scene to perform an action. The action includes, but is not limited to, at least one of body posture adjustment, walking, running, jumping, and attacking. Exemplarily, the main control virtual object is a main control virtual character such as a simulated character or a cartoon character. The first device 320 is connected to the server 340 by using a wireless network or a wired network. The server 340 includes at least one of one server, a plurality of servers, a cloud computing platform, and a virtualization center. The server 340 is configured to provide a backend service for an application program supporting a three-dimensional virtual scene. In one embodiment, the server 340 undertakes main computing work, and the first terminal 320 and the second terminal 360 undertake secondary computing work. Alternatively, the server 340 undertakes secondary computing work, and the first terminal 320 and the second terminal 360 undertake main computing work. Alternatively, the server 340, the first terminal 320, and the second terminal 360 perform collaborative computing by using a distributed computing architecture.

The second device 360 has installed and run thereon an application program supporting a virtual scene. The application program may be any one of a virtual reality application program, a three-dimensional map program, an FPS game, an MOBA game, and an SLG. The second device 360 is a device used by a second user. The second user uses the second device 360 to control other virtual objects in the virtual scene to perform an action. The action includes, but is not limited to, at least one of body posture adjustment, walking, running, jumping, and attacking. Exemplarily, the other virtual objects are other virtual characters such as simulated characters or cartoon characters.

In one embodiment, the main control virtual character and the other virtual characters are in the same virtual scene. In one embodiment, the main control virtual character and the other virtual characters may belong to the same team or the same organization, have a friend relationship, or have a temporary communication permission. In one embodiment, the main control virtual character and the second virtual characters may alternatively belong to different teams, different organizations, or two groups hostile to each other. In one embodiment, the application programs installed on the first device 320 and the second device 360 are the same, or the application programs installed on the two devices are the same type of application programs of different control system platforms. The first device 320 may generally refer to one of a plurality of devices, and the second device 360 may generally refer to one of a plurality of devices. In this embodiment, description is made by using only the first device 320 and the second device 360 as an example. Device types of the first device 320 and the second device 360 are the same or different. In the following embodiments, description is made by taking as an example that the device is a desktop computer.

There may be more or fewer devices. For example, there may be only one device, or there may be dozens of or hundreds of or more devices. The number and the device types of the devices are not limited in the embodiments of the present disclosure. The server 340 may be implemented as a physical server, or may be implemented as a cloud server. In one embodiment, when the server 340 is implemented as a cloud server, the program corresponding to the virtual scene may be a cloud game.

In some embodiments, the method provided by the embodiments of the present disclosure may be applied to a cloud game scene, so that the cloud server completes computing of data logic in a game process, and a terminal is responsible for displaying a game interface.

In one embodiment, the server 340 may alternatively be implemented as a node in a blockchain system.

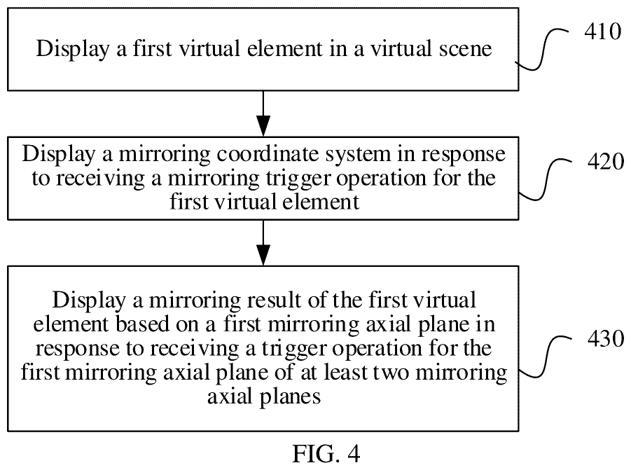

The method for editing a virtual element in a virtual scene provided by the present disclosure is described in conjunction with the foregoing brief descriptions of the terms and the application scenarios. The method may be performed by a server or a terminal, or may be performed jointly by a server and a terminal. In the embodiments of the present disclosure, the description is made by taking as an example that the method is performed by a terminal. A virtual scene based application program is installed on the terminal, and a virtual element in the virtual scene may be edited by using a UGC editor corresponding to the application program. FIG. 4 is a flowchart of a method for editing a virtual element in a virtual scene provided by one exemplary embodiment of the present disclosure. The method includes the following operations.

Operation 410: Display a first virtual element in a virtual scene.

The first virtual element is a UGC object which is an editable object. In one embodiment, the first virtual element may be a virtual object in the virtual scene, or may be a virtual moving object in the virtual scene, such as a virtual character or a virtual pet. In one embodiment, at least one virtual element exists in the virtual scene. The at least one virtual element includes a first virtual element which is an editable virtual element. A terminal interface further displays a UGC editor which is configured to provide a function of editing the first virtual element.

A selection operation for the first virtual element is received. For example, a single-click/tap operation for the first virtual element is received, and the first virtual element is selected to enter an editable mode. An editing function option is displayed correspondingly on the terminal interface. The editing function option includes a plurality of functions for editing the first virtual element. A trigger operation for a target function option under the editing function option is received. The first virtual element is edited according to a function provided by the target function option, and the edited first virtual element is displayed.

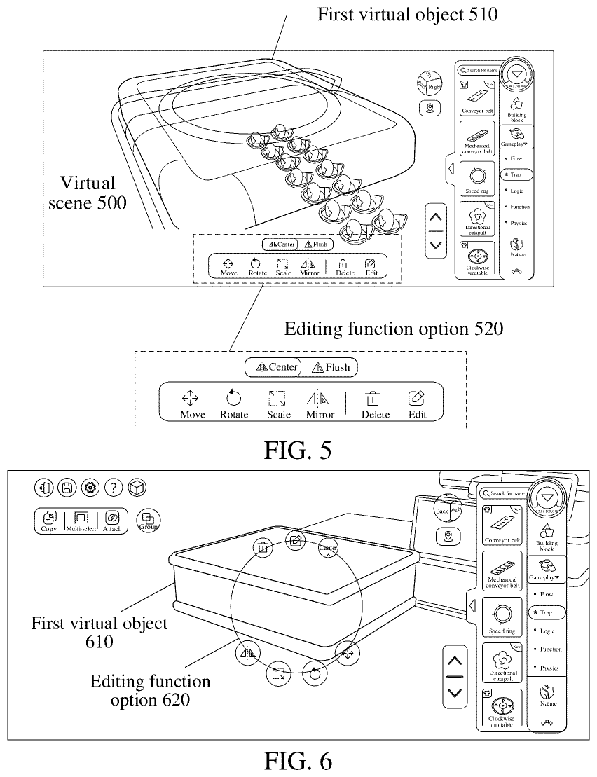

Exemplarily, FIG. 5 is a schematic diagram of one editing function option. A first virtual element 510 is displayed in a virtual scene 500. After the first virtual element 510 is selected, the first virtual element 510 enters an editable mode, and a corresponding editing function option 520 is displayed. Exemplarily, the editing function option 520 includes the following several function options:

(1) a moving function for controlling the first virtual element 510 to move and altering a location of the first virtual element 510 in the virtual scene 500; (2) a rotation function for controlling the first virtual element 510 to rotate and altering a posture and an angle of the first virtual element 510 in the virtual scene 500; (3) a scaling function for controlling a size of the first virtual element 510 to realize that the first virtual element 510 is scaled up or scaled down; (4) a mirroring function for mirroring the first virtual element 510 so that the structure of the first virtual element 510 is changed symmetrically; (5) a deletion function: after the first virtual element 510 is deleted, the first virtual element 510 being no longer displayed in the virtual scene 500; and (6) an editing function for editing a parameter such as an outline, a color, and a structure of the first virtual element 510 to change the appearance of the first virtual element 510.

In the foregoing example, only six function options are shown under the editing function option for example. Function options included under the editing function option may further be functions of other types. This is not limited in this embodiment.

The location of the editing function option in a display area may be fixed, for example, fixed at an upper left corner, a lower left corner, or a middle bottom of the terminal interface by default. Alternatively, a user may define the fixed location of the editing function option. As shown in FIG. 5, the location of the editing function option in the display area is at the middle bottom of the terminal interface. In some embodiments, to improve the flexibility and convenience of editing the first virtual element, the location of the editing function option may be changed at any time.

In some embodiments, the editing function option may alternatively be set to a follow mode. When the location of the first virtual element displayed on the terminal interface is changed by switching a viewing angle in the application program, the location of the editing function option displayed on the terminal interface will change correspondingly. For example, at a first viewing angle, the location of the first virtual element on the terminal interface is a first location, and the location of the editing function option on the terminal interface is a first relative location. When the first viewing angle is switched to a second viewing angle, the location of the first virtual element on the terminal interface is a second location, and the location of the editing function option on the terminal interface is a second relative location. Alternatively, when the first virtual element is moved in the virtual scene, the editing function option automatically follows the first virtual element. To be specific, a relative location between the first virtual element and the editing function option remains unchanged.

Exemplarily, FIG. 6 is a schematic diagram of an editing function option that follows a first virtual element.

An editing function option 620 is displayed around a first virtual element 610, and the editing function option 620 displays a plurality of function options in a circular manner. The display mode in which the editing function option follows the first virtual element includes, but is not limited to, a mode shown in FIG. 6 for example.

Operation 420: Display a mirroring coordinate system in response to receiving a mirroring trigger operation for the first virtual element.

In one embodiment, manners of receiving the mirroring trigger operation for the first virtual element include, but are not limited to: (1) displaying a virtual control corresponding to the mirroring function on the terminal interface, and sequentially receiving a selection operation for the first virtual element and a trigger operation for the virtual control; and (2) first receiving a selection operation for the first virtual element, then receiving a sliding operation, and triggering the mirroring function according to a sliding trajectory corresponding to the sliding operation.

The mirroring coordinate system includes a plurality of mirroring coordinate axes. The plurality of mirroring coordinate axes form at least two mirroring axial planes which are configured for providing flipping reference planes for mirroring the first virtual element.

Taking a three-dimensional virtual scene as an example, the mirroring coordinate system includes three mirroring coordinate axes, each corresponding to a direction in the three-dimensional virtual scene, where every two mirroring coordinate axes form a mirroring axial plane, and therefore, the mirroring coordinate system includes a total of three mirroring axial planes. In one embodiment, the mirroring coordinate system includes three mirroring coordinate axes and three mirroring axial planes, where each mirroring axial plane is formed by two mirroring coordinate axes, the mirroring coordinate axes do not coincide, and the mirroring axial planes do not coincide.

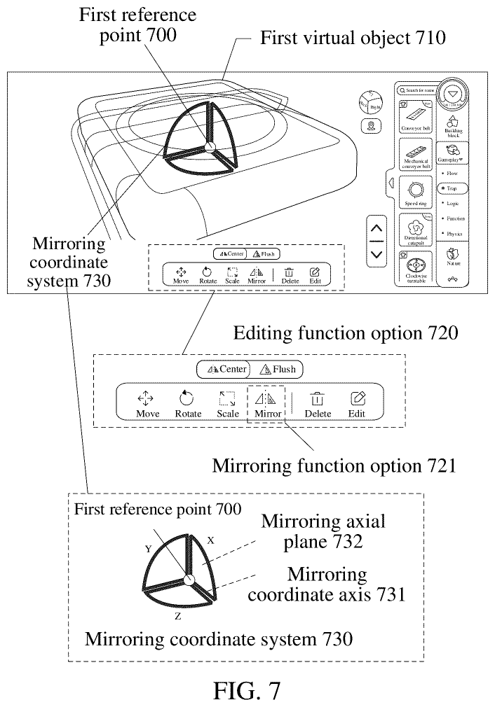

In one embodiment, the mirroring coordinate system is displayed in response to receiving a trigger operation for a mirroring option under the editing function option for the first virtual element. Exemplarily, as shown in FIG. 7, an editing function option 720 for a first virtual element 710 includes a mirroring function option 721. A mirroring coordinate system 730 is displayed when the mirroring function option 721 is triggered, e.g., when the mirroring trigger operation for the first virtual element is received. In some embodiments, the mirroring coordinate system is displayed based on a first reference point in the virtual scene in response to receiving the mirroring trigger operation for the first virtual element, where the first reference point is a location point determined based on the first virtual element (e.g., a relative location of the mirroring coordinate system and the first virtual element remain remains fixed), or the first reference point is a preset location point in the virtual scene. When the mirroring coordinate system is displayed based on the first reference point in the virtual scene, the first reference point is used as the origin of the mirroring coordinate system, and the relative location between the first virtual element and the mirroring coordinate system remains fixed. In this way, when the first virtual element is mirrored and a viewing angle is switched for the application program, symmetry and stability of an object structure are ensured, so as to avoid deviation of the mirroring coordinate system from the first virtual element due to a false touch, thereby improving the mirroring efficiency.

In addition, if the first reference point is the preset location point in the virtual scene, a uniform mirroring operation is performed on all virtual elements in the virtual scene according to a pre-designed location point as the first reference point, thereby improving regularity of mirroring, and improving the efficiency of designing the virtual scene. In one embodiment, the first reference point 700 is a center of the first virtual element 710.

As shown in FIG. 7, the first reference point 700 in the virtual scene is the origin of the mirroring coordinate system 730, and the mirroring coordinate system 730 includes a plurality of mirroring coordinate axes 731 and mirroring axial planes 732.

Operation 430: Display a mirroring result of the first virtual element based on a first mirroring axial plane in response to receiving a trigger operation for the first mirroring axial plane of the at least two mirroring axial planes.

In one embodiment, there is at least one manner of mirroring the first virtual element. Before a trigger operation for a mirroring coordinate axis of the mirroring coordinate system is received, a manner of mirroring the first virtual element is determined first.

After the mirroring trigger operation for the first virtual element is received, a mirroring option is displayed while the mirroring coordinate system is displayed.

The mirror option includes a center-based mirroring option and a flush mirroring option, where the center-based mirroring option represents that a center of the first virtual element is used as a center point of mirror flipping, and the flush mirroring option represents that a preset edge of the first virtual element is used as a central axis of mirror flipping. According to the method provided by this embodiment, two mirroring options: the center-based mirroring option and the flush mirroring option, are provided, thereby enriching the types of mirroring operations. When the center-based mirroring is performed, mirror flipping is performed on the first virtual element based on the center point of mirror flipping such that the orientation of the first virtual element is changed. Thus, the efficiency of the mirroring operation is improved. When the flush mirroring is performed, mirror flipping is performed on the first virtual element based on the central axis of mirror flipping such that the location of the first virtual element is changed. Thus, the efficiency of the mirroring operation is improved.

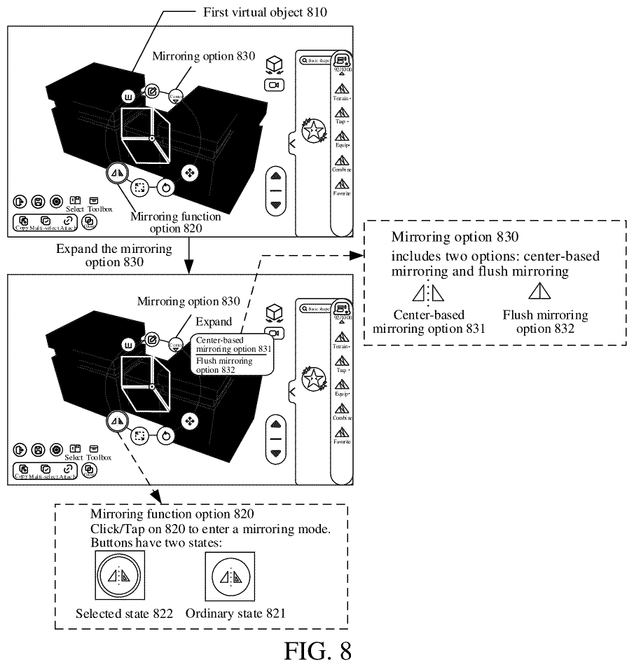

A selection operation for any one of the center-based mirroring option and the flush mirroring option under the mirroring option is received. A selection operation for a target mirroring option under the mirroring option is received. The target mirroring option includes any one of the center-based mirroring option and the flush mirroring option. Exemplarily, FIG. 8 is a schematic diagram of a process of selecting a target mirroring option. After a mirroring function option 820 corresponding to a first virtual element 810 is triggered, a control corresponding to the mirroring function option 820 changes in form, e.g., changes from an ordinary state 821 to a selected state 822. At this point, a center-based mirroring option 831 and a flush mirroring option 832 may be displayed by triggering a mirroring option 830, and any one of the center-based mirroring option and the flush mirroring option is selected as the target mirroring option. After the target mirroring option is determined, a trigger operation for a first mirroring axial plane of the at least two mirroring axial planes is received and a mirroring result of the first virtual element with the first mirroring axial plane as a flipping reference plane is displayed.

In one embodiment, the mirroring result of mirror flipping of the first virtual element with the center of the first virtual element as the center point of mirror flipping and the first mirroring axial plane as the flipping reference plane is displayed in response to receiving the trigger operation for the first mirroring axial plane of the at least two mirroring axial planes and the center-based mirroring option being selected.

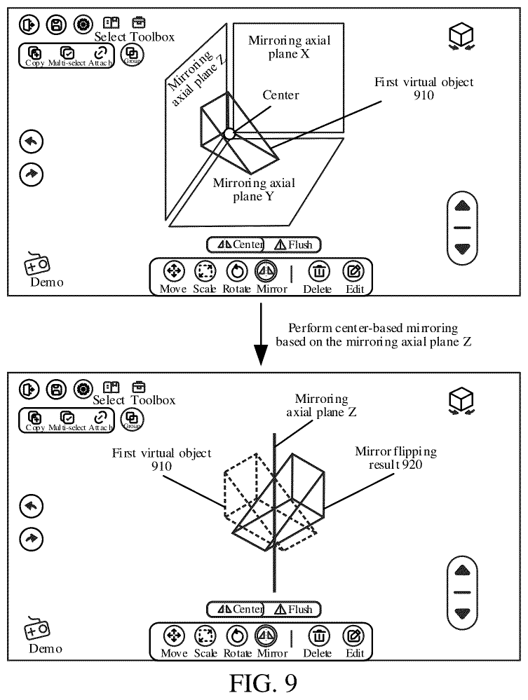

Exemplarily, FIG. 9 is a schematic diagram of center-based mirroring on a first virtual element. A center of the first virtual element 910 is an origin of a mirroring coordinate system. To be specific, the center of the first virtual element is used as a center point of mirror flipping. The mirroring coordinate system includes three mirroring axial planes, which are a mirroring axial plane X, a mirroring axial plane Y, and a mirroring axial plane Z, respectively.

Exemplarily, with the mirroring axial plane Z as a first mirroring axial plane, mirror flipping is performed on the first virtual element 910 to obtain a mirror flipping result 920. The mirror flipping result 920 and the first virtual element 910 are mirrored about the mirroring axial plane Z.

After mirror flipping is performed on the first virtual element 910, only the mirror flipping result 920 is displayed, and a frame of the first virtual element 910 is bounded with dashed lines to illustrate changes before and after the first virtual element 910 is flipped.

In one embodiment, the mirroring result of mirror flipping of the first virtual element with a first edge of the first virtual element as the central axis of mirror flipping and the first mirroring axial plane as the flipping reference plane is displayed in response to receiving the trigger operation for the first mirroring axial plane of the at least two mirroring axial planes and the flush mirroring option being selected.

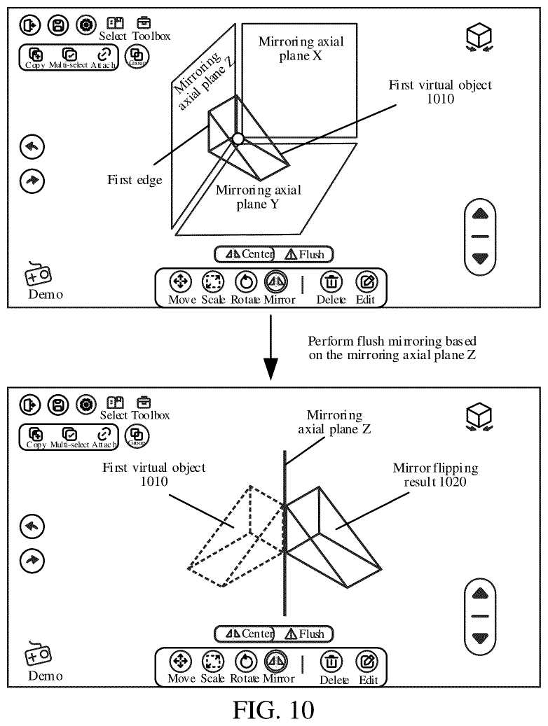

Exemplarily, FIG. 10 is a schematic diagram of flush mirroring on a first virtual element. A first edge of the first virtual element 1010 is a central axis of mirror flipping. A mirroring coordinate system includes three mirroring axial planes, which are a mirroring axial plane X, a mirroring axial plane Y, and a mirroring axial plane Z, respectively. Exemplarily, with the mirroring axial plane Z as a first mirroring axial plane, mirror flipping is performed on the first virtual element 1010 to obtain a mirror flipping result 1020. The mirror flipping result 1020 and the first virtual element 1010 are mirrored about the mirroring axial plane Z. In one embodiment, if the first edge is a straight line, the straight line is used as the central axis of mirror flipping. If the first edge is a curve, a tangent line of the selected combined edge is used as the central axis of mirror flipping. After mirror flipping is performed on the first virtual element 1010, only the mirror flipping result 1020 is displayed, and a frame of the first virtual element 1010 is bounded with dashed lines to illustrate changes before and after the first virtual element 1010 is flipped.

In some embodiments, a plurality of mirroring axial planes may be selected at the same time to perform mirror flipping on the first virtual element. This includes the following several cases.

1. Sequential mirroring results of the first virtual element with a plurality of mirroring axial planes as the flipping reference planes are displayed in response to receiving a trigger operation for the plurality of mirroring axial planes of the at least two mirroring axial planes, where the mirror flipping process of the first virtual element conforms to a first selection sequence which is configured for indicating an order that the plurality of mirroring axial planes are selected.

Exemplarily, if a first mirroring axial plane and a second mirroring axial plane are selected in sequence, the mirroring results refer to a first mirroring result (at a second location) of flipping of the first virtual element (at a first location) with the first mirroring axial plane as the flipping reference plane being displayed first, and then a second mirroring result (at a third location) of flipping of the first virtual element (at the first location) with the second mirroring axial plane as the flipping reference plane being displayed. In the mirroring process, the number of the first virtual elements is increased to 2, and the location of the first virtual element is changed from the first location to the second location and the third location.

2. Simultaneous mirroring results of the first virtual element with the plurality of mirroring axial planes as the flipping reference planes are displayed in response to receiving the trigger operation for the plurality of mirroring axial planes of the at least two mirroring axial planes.

Exemplarily, if the first mirroring axial plane and the second mirroring axial plane are selected in sequence, the mirroring results refer to the first mirroring result (at the second location) of flipping of the first virtual element (at the first location) with the first mirroring axial plane as the flipping reference plane and the second mirroring result (at the third location) of flipping of the first virtual element (at the first location) with the second mirroring axial plane as the flipping reference plane being displayed simultaneously. In the mirroring process, the number of the first virtual elements is increased to 2, and the location of the first virtual element is changed from the first location to the second location and the third location.

3. Mirroring results of the first virtual element with the plurality of mirroring axial planes as the flipping reference planes are displayed in response to receiving the trigger operation for the plurality of mirroring axial planes of the at least two mirroring axial planes, where in the mirroring process of the first virtual element, a flipping process based on an i+1^{th} mirroring axial plane is performed based on a flipping result for an i^{th} mirroring axial plane, i being a positive integer.

Exemplarily, if the first mirroring axial plane and the second mirroring axial plane are selected in sequence, the mirroring results refer to the process of flipping of the first virtual element (at the first location) with the first mirroring axial plane as the flipping reference plane being displayed first (at this point, the first virtual element is at the second location), and then the mirroring result (at the third location) of flipping of the first virtual element (at the second location) with the second mirroring axial plane as the flipping reference plane being displayed. In the mirroring process, the number of the first virtual elements remains unchanged, and the location of the first virtual element is changed from the first location to the third location.

A plurality of times of mirroring of the first virtual element are triggered with the plurality of mirroring axial planes, thereby improving efficiency of mirroring the first virtual element. Mirroring of the first virtual element according to accumulation of times is avoided, and the human-computer interaction efficiency is improved.

In some embodiments, to improve the interest of the process of mirroring the first virtual element and make mirroring results richer, the appearance of the mirroring axial plane may further be set before mirroring such that the appearance of the first virtual element is altered correspondingly after the first virtual element is flipped about the mirroring axial plane.

A representation feature option corresponding to the first mirroring axial plane is displayed in response to receiving a selection operation for the first mirroring axial plane of the at least two mirroring axial planes, the representation feature option being configured to adjust an appearance representation of the first mirroring axial plane. The first mirroring axial plane with a first representation feature as the appearance representation is displayed in response to receiving a trigger operation for a first representation feature option. A mirroring result of the first virtual element with the first mirroring axial plane as the flipping reference plane and the first representation feature as the appearance representation is displayed in response to receiving the trigger operation for the first mirroring axial plane of the at least two mirroring axial planes.

Exemplarily, the representation feature option for the first mirroring axial plane includes: (1) a color option configured to alter the color of the first mirroring axial plane; (2) a volume option configured to alter the size of the first mirroring axial plane; (3) a texture option configured to alter the texture of the first mirroring axial plane and the like; and (4) an effect option configured to overlay an effect onto the first mirroring axial plane, such as a flickering effect, a flickering effect, or an edge highlighting effect.

In one embodiment, the first representation feature includes: setting the color of the first mirroring axial plane to blue, setting the volume of the first mirroring axial plane to be twice a default volume, and setting the texture of the first mirroring axial plane to speckles.

Then, when the first virtual element is flipped with the first mirroring axial plane as the flipping reference plane, the corresponding mirroring result is as follows: the color of the mirrored first virtual element is overlaid with the blue filter, the volume changes to be twice the default volume, and there are speckles on the outer surface.

A plurality of ones under the representation feature option described above may be implemented separately, or may be implemented together in a matching manner. This is not limited in this embodiment.

With the representation feature option provided, when the first virtual element is mirrored, representation features, such as the color setting and the volume setting described above, are configured for the mirroring result in conjunction with the selected first representation feature option. Thus, the efficiency of designing and configuring the appearance of a mirroring result in a mirroring process is improved. After mirroring, there is no need to additionally set an appearance feature of a mirrored element. The human-computer interaction efficiency of designing a virtual element is improved. In some embodiments, if an operation triggering a mirroring axial plane is a false touch, the mirroring operation may alternatively be canceled within a preset time. In this case, the first virtual element remains unchanged.

In one embodiment, a trigger operation for a first mirroring axial plane of at least two mirroring axial planes is received; and mirroring cancel prompt information is displayed in response to receiving a mirroring cancel operation within a preset duration after the trigger operation for the first mirroring axial plane is received.

Exemplarily, the preset duration is one second. Types of the mirroring cancel operation include, but are not limited to: (1) triggering the first mirroring axial plane again within the preset duration; (2) sliding for cancellation within the preset duration, where a sliding gesture may be arbitrary; and (3) triggering a target virtual control corresponding to the mirroring cancel operation within the preset duration.

To sum up, according to the method provided by the present application, by receiving the mirroring trigger operation for the first virtual element (a UGC object), the mirroring coordinate system is displayed. A plurality of mirroring axial planes in the mirroring coordinate system can provide flipping reference planes for mirroring the first virtual element, thereby improving convenience when a user edits the first virtual element. By receiving the trigger operation for the mirroring axial plane, the mirroring result of the first virtual element after flipping based on a mirroring axial plane can be automatically displayed, so that the structure presentation effect of the first virtual element is clearer and more visual, thereby improving the efficiency of designing the structure of the first virtual element by the user.

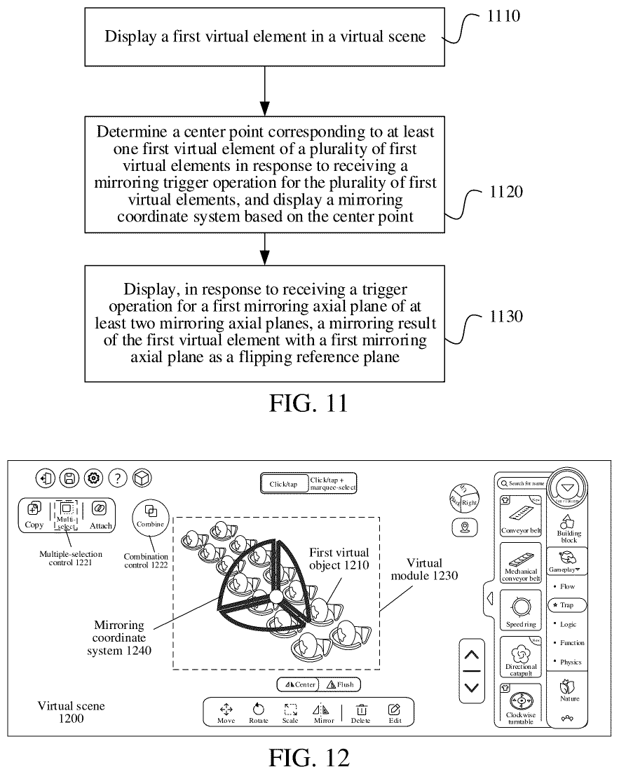

The foregoing embodiments are described by taking as an example that one first virtual element is edited. In some embodiments, a plurality of editable first virtual elements are present in the virtual scene, and a multiple-selection function provided by the UGC editor may be utilized to simultaneously select a plurality of first virtual elements for editing. FIG. 11 is a flowchart of a method for editing a plurality of first virtual elements provided by one exemplary embodiment of the present disclosure. The method is performed by a terminal and includes the following operations.

Operation 1110: Display a first virtual element in a virtual scene.

The first virtual element is a UGC object which is an editable object.

In one embodiment, a plurality of first virtual elements are present in the virtual scene. A shape and a size of each first virtual element may be arbitrary. All editable virtual elements may be referred to as first virtual elements. Virtual elements may be classified in any manner, e.g., by a shape, a size, a color, and symmetry of a virtual element.

Operation 1120: Determine a center point corresponding to at least one first virtual element of a plurality of first virtual elements in response to receiving a mirroring trigger operation for the plurality of first virtual elements; and display a mirroring coordinate system based on the center point.

The mirroring trigger operation is an operation for the plurality of first virtual elements. Exemplarily, FIG. 12 is a schematic diagram of selecting a plurality of first virtual elements. A plurality of first virtual elements 1210 are present in a virtual scene 1200. Any number of first virtual elements 1210 may be selected by triggering a multiple-selection control 1221.

Selection modes corresponding to the multiple-selection control 1221 include: (1) clicking/tapping: clicking/tapping on different first virtual elements 1210 a plurality of times for multiple selection; and (2) clicking/tapping plus marquee selection: receiving a slide, and automatically displaying, according to a sliding operation, a dashed box including the first virtual elements 1210, the first virtual element 1210 located in the dashed box being selected. If the first virtual elements 1210 are widely scattered so that all first virtual elements 1210 needing to be edited cannot be marquee-selected only via the sliding operation, unselected first virtual elements 1210 may be clicked/tapped, and all first virtual elements 1210 selected via the clicking/tapping operation and the marquee selection operation are jointly used as the selected first virtual elements 1210.

The determination of the center point corresponding to at least one first virtual element of the plurality of first virtual elements includes, but is not limited to, the following several cases. (1) The plurality of first virtual elements are arranged according to the sequence in which the first virtual elements are selected. A serial number corresponding to each first virtual element is determined. One of the serial numbers is selected according to a preset requirement, and the center point of the first virtual element corresponding to the selected serial number as a center point for displaying the mirroring coordinate system. For example, three first virtual elements are selected, and the center point of the first virtual element with the serial number of 3 is used as the center point for displaying the mirroring coordinate system. (2) A combining operation is performed on a plurality of selected first virtual elements to combine at least one first virtual element of the plurality of first virtual elements into a virtual module, and a center point of the virtual module is used as the center point for displaying the mirroring coordinate system. For example, five first virtual elements are selected and combined into a virtual module, and the center point of the virtual module is used as the center point for displaying the mirroring coordinate system. The mirroring coordinate system is displayed based on the first reference point. Alternatively, five first virtual elements are selected, three of which are combined into a virtual module, and a center point of the virtual module is used as the center point for displaying the mirroring coordinate system. In one embodiment, when a mirroring trigger operation for a plurality of first virtual elements, a combining selection operation for at least one first virtual element of the plurality of first virtual elements is received, the combining selection operation being configured for combining the selected at least one virtual element to obtain a virtual module; and a center point corresponding to the virtual module is determined, and the mirroring coordinate system is displayed based on the center point of the virtual module.

Exemplarily, as shown in FIG. 12, by triggering a combination control 1222, any number of first virtual elements 1210 may be selected for combination to obtain a corresponding virtual module 1230. Exemplarily, a plurality of selected first virtual elements 1210 are all combined to obtain the virtual module 1230, and the mirroring coordinate system 1240 is displayed based on the center point of the virtual module 1230.

A mirroring trigger operation for a plurality of first virtual elements may be received and a location of the first reference point may be determined according to the plurality of first virtual elements so as to display the mirroring coordinate system, thereby achieving simultaneous mirroring of the plurality of first virtual elements. The plurality of first virtual elements may be combined to obtain the corresponding virtual module. Thus, the complexity and symmetry of a virtual element structure can be improved.

Operation 1130: Display, in response to receiving the trigger operation for the first mirroring axial plane of the at least two mirroring axial planes, the mirroring result of the first virtual element with the first mirroring axial plane as the flipping reference plane.

In one embodiment, there is at least one manner of mirroring the first virtual element. Before a trigger operation for a mirroring coordinate axis of the mirroring coordinate system is received, a manner of mirroring the first virtual element is determined first.

After the mirroring trigger operation for the first virtual element is received, a mirroring option is displayed while the mirroring coordinate system is displayed.

The mirror option includes a center-based mirroring option and a flush mirroring option, where the center-based mirroring option represents that a center of the first virtual element is used as a center point of mirror flipping, and the flush mirroring option represents that a preset edge of the first virtual element is used as a central axis of mirror flipping. A selection operation for a target mirroring option under the mirroring option is received. The target mirroring option includes any one of the center-based mirroring option and the flush mirroring option. In one embodiment, when the target mirroring option is the center-based mirroring option and the first mirroring axial plane is used as the flipping reference plane, the mirroring results of mirror flipping of a plurality of first virtual elements include the following several cases.

1.1. The mirroring results of mirror flipping of the plurality of first virtual elements with a combined center of the plurality of first virtual elements as the center point of mirror flipping and the first mirroring axial plane as the flipping reference plane are displayed in response to receiving the trigger operation for the first mirroring axial plane of the at least two mirroring axial planes and the center-based mirroring option being selected.

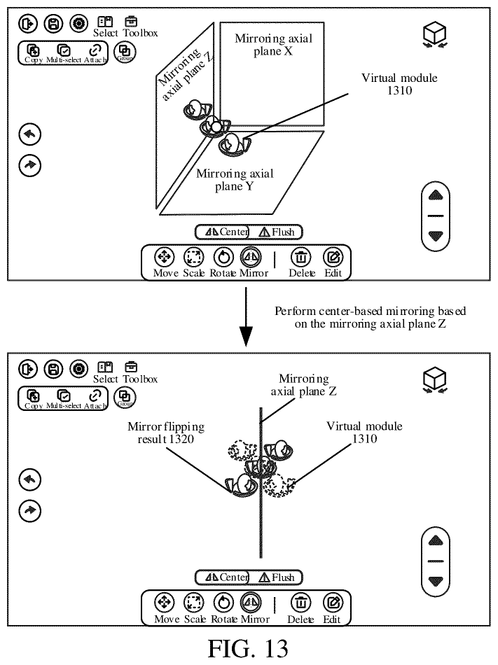

FIG. 13 is a schematic diagram of center-based mirroring on a virtual module corresponding to a first virtual element.

A center of the virtual module 1310 formed by combining a plurality of first virtual elements is an origin of a mirroring coordinate system. To be specific, the center of the virtual module 1310 is used as a center point of mirror flipping. The mirroring coordinate system includes three mirroring axial planes, which are a mirroring axial plane X, a mirroring axial plane Y, and a mirroring axial plane Z, respectively.

Exemplarily, with the mirroring axial plane Z as a first mirroring axial plane, mirror flipping is performed on the virtual module 1310 to obtain a mirror flipping result 1320. The mirror flipping result 1320 and the virtual module 1310 are mirrored about the mirroring axial plane Z.

After mirror flipping is performed on the virtual module 1310, only the mirror flipping result 1320 is displayed, and a frame of the virtual module 1310 is bounded with dashed lines to illustrate changes before and after the virtual module 1310 is flipped.

With the combined center of the plurality of first virtual elements as the center point of mirror flipping, the integrity of the plurality of first virtual elements and the regularity of integrally mirroring the plurality of first virtual elements are improved, and the efficiency of mirroring the plurality of first virtual elements is improved.

1.2. The mirroring results of mirror flipping of the plurality of first virtual elements with a center of a specified virtual element of the plurality of first virtual elements as the center point of mirror flipping and the first mirroring axial plane as the flipping reference plane are displayed in response to receiving the trigger operation for the first mirroring axial plane of the at least two mirroring axial planes and the center-based mirroring option being selected.

With the combined center of the virtual module or the center point of the specified virtual element in the virtual module as the center point of mirror flipping, center-based mirroring is performed on the virtual module to alter the position of the virtual module. Thus, the efficiency of mirroring a batch of virtual elements is improved.

The specified virtual element is a virtual element of the plurality of first virtual elements that meets a selection sequence condition which is configured for indicating an order requirement for the specified virtual element to be selected from the plurality of first virtual elements for mirror flipping.

In one embodiment, meeting the selection sequence condition means that the specified virtual element is the last selected first virtual element of the plurality of first virtual elements.

The plurality of first virtual elements are sorted in ascending order according to the sequence in which the first virtual elements are selected. Each first virtual element has a respective serial number. A first virtual element of which the serial number is the largest is determined as the specified virtual element. Exemplarily, a total of five first virtual elements are selected and sorted in ascending order according to the sequence of selection, with respective serial numbers being 1, 2, 3, 4, and 5. The first virtual element of which the serial number is 5 is used as the specified virtual element, and the center of the specified virtual element is used as the center point of mirror flipping.

The selection sequence condition may be arbitrary. In addition to the foregoing exemplary determining manner based on the selection sequence condition, any other manner may alternatively be adopted for determining the specified virtual element from the plurality of first virtual elements. This is not limited in this embodiment.

With the center of the specified virtual element of the plurality of first virtual elements as the center point of mirror flipping, the flexibility of integrally mirroring the plurality of first virtual elements is improved, a selection range for mirroring reference points when the plurality of first virtual elements are integrally mirrored is widened, and the efficiency of mirroring the plurality of first virtual elements is improved.

The specified virtual element of the plurality of first virtual elements is determined according to the selection sequence. In the process of selection from the plurality of first virtual elements, the specified virtual element is implied in the process of selecting the plurality of first virtual elements, and the specified virtual element does not need to be additionally selected from the plurality of first virtual elements. Thus, the efficiency of selecting the specified virtual element is improved.

In one embodiment, when the target mirroring option is the flush mirroring option and the first mirroring axial plane is used as the flipping reference plane, the mirroring results of mirror flipping of a plurality of first virtual elements include the following several cases.

2.1. The mirroring results of mirror flipping of the plurality of first virtual elements with a combined edge of the plurality of first virtual elements as the central axis of mirror flipping and the first mirroring axial plane as the flipping reference plane are displayed in response to receiving the trigger operation for the first mirroring axial plane of the at least two mirroring axial planes and the flush mirroring option being selected.

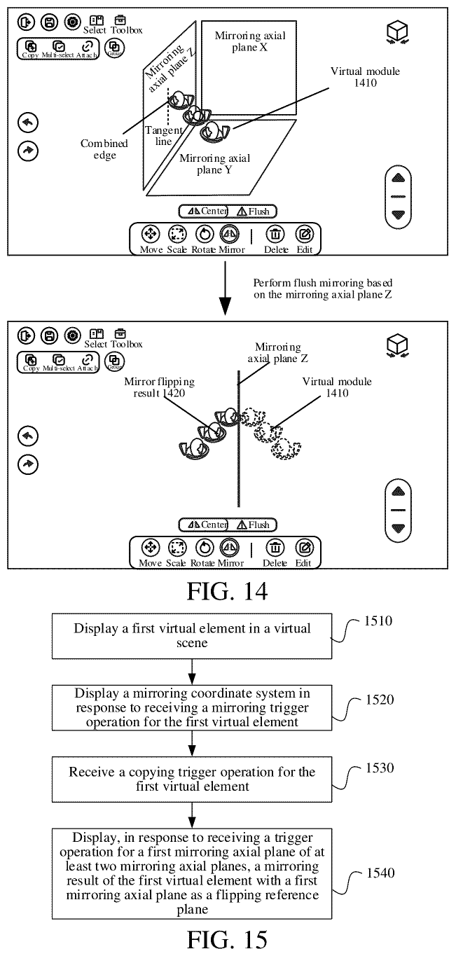

FIG. 14 is a schematic diagram of flush mirroring on a virtual module corresponding to first virtual elements.

A combined edge of the virtual module 1410 formed by combining a plurality of first virtual elements is used as a central axis of mirror flipping. A mirroring coordinate system includes three mirroring axial planes, which are a mirroring axial plane X, a mirroring axial plane Y, and a mirroring axial plane Z, respectively.

In one embodiment, if the combined edge is a straight line, the straight line is used as the central axis of mirror flipping. If the combined edge is a curve, a tangent line of the selected combined edge is used as the central axis of mirror flipping.

Exemplarily, with the mirroring axial plane Z as a first mirroring axial plane, mirror flipping is performed on the virtual module 1410 to obtain a mirror flipping result 1420. The mirror flipping result 1420 and the virtual module 1410 are mirrored about the mirroring axial plane Z.

After mirror flipping is performed on the virtual module 1410, only the mirror flipping result 1420 is displayed, and a frame of the virtual module 1410 is bounded with dashed lines to illustrate changes before and after the virtual module 1410 is flipped.

With the combined edge of the plurality of first virtual elements as the central axis of mirror flipping, the integrity of the plurality of first virtual elements and the regularity of integrally mirroring the plurality of first virtual elements are improved, and the efficiency of mirroring the plurality of first virtual elements is improved.

2.2. The mirroring results of mirror flipping of the plurality of first virtual elements with a second edge of a specified virtual element of the plurality of first virtual elements as the central axis of mirror flipping and the first mirroring axial plane as the flipping reference plane are displayed in response to receiving the trigger operation for the first mirroring axial plane of the at least two mirroring axial planes and the flush mirroring option being selected.

According to the method provided by this embodiment, with the combined edge of the virtual module or the first edge of the specified virtual element in the virtual module as the central axis of mirror flipping, flush mirroring is performed on the virtual module to alter the location of the virtual module. Thus, the efficiency of mirroring a batch of virtual elements is improved.

The specified virtual element is a virtual element of the plurality of first virtual elements that meets a selection sequence condition which is configured for indicating an order requirement for the specified virtual element to be selected from the plurality of first virtual elements for mirror flipping.

With the second edge of the specified virtual element of the plurality of first virtual elements as the central axis of mirror flipping, the flexibility of integrally mirroring the plurality of first virtual elements is improved, a selection range for mirroring reference axes when the plurality of first virtual elements are integrally mirrored is widened, and the efficiency of mirroring the plurality of first virtual elements is improved.

In some embodiments, a plurality of first virtual elements forms a complete virtual module. In addition to the virtual module is edited (e.g., an operation such as mirroring) as a whole, part of the first virtual elements in the virtual module may alternatively be edited, and only forms of this part of first virtual elements are changed.

Exemplarily, the following description is made by taking as an example that a mirroring trigger operation for part of the first virtual elements in the virtual module is received.

There are three first virtual elements that together form a virtual module B, which are a first virtual element A1, a first virtual element A2, and a first virtual element A3, respectively. Center-based mirroring is performed only on the first virtual element A1, and a corresponding mirroring result is a first mirrored virtual element A11. The first mirror virtual element A11 still belongs to the virtual module B. To be specific, in this case, the virtual module B is constituted by the first mirrored virtual element A11, the first virtual element A2, and the first virtual element A3.

In some embodiments, regarding the combination of a plurality of first virtual elements, in addition to the foregoing exemplary determination of a plurality of first virtual elements into a complete virtual module via the combination control, other virtual elements may alternatively be attached to a first virtual element, so that the other virtual elements can change along with the first virtual element.

Exemplarily, the first virtual element is attached with at least one second virtual element that follows the first virtual element.

Mirroring results of both the first virtual element and the at least one second virtual element with the first mirroring axial plane as the flipping reference plane are displayed in response to receiving the trigger operation for the first mirroring axial plane of the at least two mirroring axial planes.

A plurality of second virtual elements may be attached to the first virtual element, and other virtual elements may further be attached to the second virtual elements. This attachment relationship may alternatively be referred to as a parent-child relationship. To be specific, the first virtual element is a parent object, and the second virtual element is a child object. A plurality of child objects may be attached to a parent object, but one child object can only be attached to one parent object. Each child object may serve as a parent object and may be attached with the child object itself.

When a parent object is edited, the child objects will inherit the edit attributes of the parent object. To be specific, after an editing operation is performed on the parent object, and the child objects also correspondingly display the editing result after the same editing operation. When only a child object is edited, the parent object remains unchanged.

Exemplarily, the first virtual element A is attached with a second virtual element B, and the second virtual element B is attached with a third virtual element C.

Then, when only the first virtual element A is edited, the second virtual element B and the third virtual element C both correspondingly display the same editing result. When only the second virtual element B is edited, the third virtual element C correspondingly displays the same editing result, but the first virtual element A remains unchanged. When only the third virtual element C is edited, neither the first virtual element A nor the second virtual element B changes.

The number and types of other virtual elements attached to each virtual element may be arbitrary, and the form after attachment may be arbitrary. Both are not limited in this embodiment.

To sum up, according to the method provided by the present application, by receiving the mirroring trigger operation for the first virtual element (a UGC object), the mirroring coordinate system is displayed. A plurality of mirroring axial planes in the mirroring coordinate system can provide flipping reference planes for mirroring the first virtual element, thereby improving convenience when a user edits the first virtual element. By receiving the trigger operation for the mirroring axial plane, the mirroring result of the first virtual element after flipping based on a mirroring axial plane can be automatically displayed, so that the structure presentation effect of the first virtual element is clearer and more visual, thereby improving the efficiency of designing the structure of the first virtual element by the user.

According to the method provided by this embodiment, by establishing the attachment relationship between the first virtual element and the second virtual element, the editing process can be realized for both the first virtual element and the second virtual element by performing an operation only on the first virtual element, and the corresponding editing result is displayed. Thus, the efficiency and flexibility of editing are improved.

When a virtual element in the virtual scene is edited, in addition to mirroring the virtual element via the mirroring function option as described in the foregoing several embodiments, other types of editing operations may be superposed with a mirroring operation to jointly control the virtual element. For example, the operation of copying the virtual element is combined with the operation of mirroring the virtual element. FIG. 15 is a flowchart of a method for simultaneously mirroring and copying a first virtual element provided by one exemplary embodiment of the present disclosure. The method includes the following operations.

Operation 1510: Display a first virtual element in a virtual scene.

The first virtual element is a UGC object which is an editable object.

Operation 1520: Display a mirroring coordinate system in response to receiving a mirroring trigger operation for the first virtual element.

The mirroring coordinate system includes a plurality of mirroring coordinate axes. The plurality of mirroring coordinate axes form at least two mirroring axial planes which are configured for providing flipping reference planes for mirroring the first virtual element.

Operation 1530: Receive a copying trigger operation for the first virtual element.

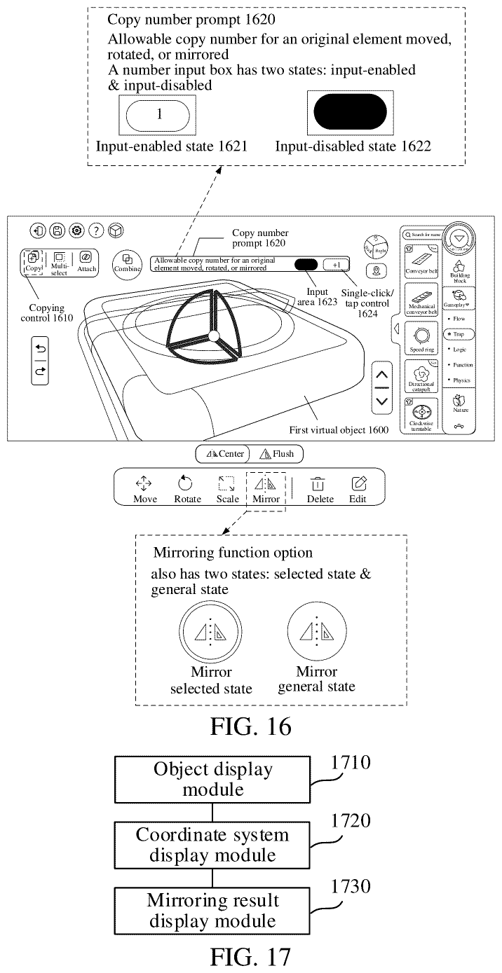

Exemplarily, FIG. 16 is a schematic diagram of triggering copying of a first virtual element.

After a copying control 1610 is triggered, a copy number prompt 1620 is displayed. The copy number prompt 1620 is configured for prompting whether a currently selected first virtual element 1600 can be copied. The copy number prompt 1620 corresponds to an input area 1623 for a copy number and a single-click/tap control 1624.

If copying cannot be performed, the input area 1623 is presented in an input-disabled state 1621. If copying can be performed, the input area 1623 is presented in an input-enabled state 1622.

When the first virtual element 1600 can be copied, a copy number may be entered in the input area 1623. For example, if the number 2 is entered, the number of copied first virtual elements 1600 is 2. The number in the input area 1623 may be modified by triggering the single-click/tap control 1624. Each time the single-click/tap control 1624 is triggered, the copy number is increased by one. A default value in the input area 1623 is 1.

Exemplarily, the copy number prompt 1620 in FIG. 16 indicates that the first virtual element 1600 can be copied.

Operation 1540: Display, in response to receiving the trigger operation for the first mirroring axial plane of the at least two mirroring axial planes, the mirroring result of the first virtual element with the first mirroring axial plane as the flipping reference plane.

A first copied virtual element corresponding to the first virtual element is displayed based on the copying trigger operation as the mirroring result of the first virtual element with the first mirroring axial plane as the flipping reference plane in response to receiving the trigger operation for the first mirroring axial plane of the at least two mirroring axial planes.

The superlocation effect of the copying operation and the mirroring operation is that a mirrored virtual element is copied based on an original virtual element. To be specific, in addition to the first copied virtual element after mirroring, the mirroring result of the first virtual element with the first mirroring axial plane as the flipping reference plane further includes the original first virtual element.

In some embodiments, in addition to the aforementioned manner of realizing the copying operation by triggering the copying control, the process of copying the first virtual element may alternatively be realized by dragging a mirroring coordinate axis. The virtual element obtained via the copying operation is identical to the first virtual element, e.g., has no mirror relationship therewith.

In one embodiment, the process of dragging for copying may be performed before operation 1540, or may be performed after operation 1540. This embodiment is described by taking as an example that the process is performed before operation 1540.

The first virtual element is copied in a dragging direction along a first mirroring coordinate axis and a second copied virtual element is displayed in response to receiving a drag operation for the first mirroring coordinate axis of the plurality of mirroring coordinate axes.

After the second copied virtual element is obtained, operation 1540 is performed, and the first virtual element and the second copied virtual element may be mirrored synchronously. To be specific, mirroring results of both the first virtual element and the second virtual element with the first mirroring axial plane as the flipping reference plane are displayed in response to receiving the trigger operation for the first mirroring axial plane of the at least two mirroring axial planes. The first virtual element is first copied via the drag operation to obtain the second copied virtual element so that the first virtual element and the second copied virtual element obtained through copying are mirrored synchronously as a whole. Thus, the human-computer interaction efficiency of the copying and mirroring operations are improved.

Operation 1510 to operation 1540 are described by taking as an example that the copying and mirroring operations are performed on one first virtual element. In some embodiments, a plurality of first virtual elements may be selected simultaneously, and the selected plurality of first virtual elements are copied and mirrored simultaneously to obtain a plurality of first mirrored virtual elements.

In one embodiment, a copying trigger operation for the at least one first virtual element is received. There may be a combination relationship or there may be no combination relationship between the at least one first virtual element.

The mirroring result of the at least one first virtual element with the first mirroring axial plane as the flipping reference plane is displayed in response to receiving the trigger operation for the first mirroring axial plane of the at least two mirroring axial planes.

Exemplarily, two first virtual elements are selected, which are a first virtual element A and a first virtual element B, respectively. The following description is made by taking as an example that there is no combination relationship between the first virtual element A and the first virtual element B.

(1) A copying operation is triggered via a copying control.

A mirrored virtual element A1 of the first virtual element A and a mirrored virtual element B1 of the first virtual element B are obtained, and mirroring results include a total of four virtual elements, which are A, B, A1, and B1, respectively.

(2) A copying operation is triggered by dragging.

In a first case, mirroring is performed after copying. Firstly, a first mirroring coordinate axis in a mirroring coordinate system is dragged to simultaneously copy the first virtual element A and the first virtual element B to obtain a first virtual element C and a first virtual element D. A first mirroring axial plane in the mirroring coordinate system is then triggered to simultaneously mirror the first virtual elements A, B, C, and D to obtain four mirrored virtual elements A1, B1, C1, and D4 as the mirroring results.

In a second case, copying is performed after mirroring. Firstly, the first mirroring axial plane in the mirroring coordinate system is triggered to simultaneously mirror the first virtual elements A and B to obtain two mirrored virtual elements A1 and B1. The first mirroring coordinate axis in the mirroring coordinate system is then dragged to simultaneously copy the first virtual element A1 and the first virtual element B1 to obtain two copied virtual elements C1 and D1. Thus, the mirroring results include a total of four virtual elements A1, B1, C1, and D1.

Exemplarily, three first virtual elements are selected, which are a first virtual element A, a first virtual element B, and a first virtual element C, respectively. The following description is made by taking as an example that there is a combination relationship among the first virtual element A, the first virtual element B, and the first virtual element C. The three first virtual elements together form a virtual module.

In this case, regardless of copying by dragging or copying by triggering the copying control, there are the following several cases: (1) Taking the virtual module as a whole, the virtual module is copied first and then mirrored, or mirrored first and then copied. (2) Only part of the first virtual elements in the virtual module are copied first and then mirrored, or mirrored first and then copied.

In some embodiments, simultaneous mirroring and copying may be realized by attaching other virtual elements to the first virtual element so that the other virtual elements can follow the first virtual element.

Exemplarily, the first virtual element is attached with at least one second virtual element that follows the first virtual element. A plurality of second virtual elements may be attached to the first virtual element, and other virtual elements may further be attached to the second virtual elements. This attachment relationship may alternatively be referred to as a parent-child relationship. To be specific, the first virtual element is a parent object, and the second virtual element is a child object.

The first virtual element and the second virtual element attached to the first virtual element are mirrored integrally according to the attachment relationship. Thus, the mirroring efficiency is improved.

When a parent object is edited, the child objects will inherit the edit attributes of the parent object. To be specific, after an editing operation is performed on the parent object, and the child objects also correspondingly display the editing result after the same editing operation. When only a child object is edited, the parent object remains unchanged. In one embodiment, the copying trigger operation for the first virtual element is received. Since the first virtual element is a parent object, the copying trigger operation is an operation for both the first virtual element and the second virtual element.

Mirroring results of both the first virtual element and the at least one second virtual element with the first mirroring axial plane as the flipping reference plane are displayed in response to receiving the trigger operation for the first mirroring axial plane of the at least two mirroring axial planes. By simultaneously copying and processing the first virtual element and the second virtual element attached to the first virtual element via the copying trigger operation and the mirroring operation, the human-computer interaction efficiency is improved, and a complicated process of separately performing the copying operation and the mirroring operation on each element is avoided. In one embodiment, the copying trigger operation for the at least one second virtual element is received. Since the second virtual element is a child object, the copying trigger operation is only directed to the second virtual element without affecting the first virtual element.

A plurality of third copied virtual elements corresponding to the at least one second virtual element are displayed in response to receiving the trigger operation for the first mirroring axial plane of the at least two mirroring axial planes, the plurality of third copied virtual elements being mirroring results of the at least one second virtual element with the first mirroring axial plane as the flipping reference plane, where the plurality of third copied virtual elements are attached to the first virtual element.

The second virtual element attached to the first virtual element may be separately copied and mirrored, so that the third mirrored virtual element inherits an additional attribute of the second virtual element and is also attached to the first virtual element. Thus, the flexibility of processing a virtual element attached to the first virtual element is improved.

To sum up, according to the method provided by the present application, by receiving the mirroring trigger operation for the first virtual element (a UGC object), the mirroring coordinate system is displayed. A plurality of mirroring axial planes in the mirroring coordinate system can provide flipping reference planes for mirroring the first virtual element, thereby improving convenience when a user edits the first virtual element. By receiving the trigger operation for the mirroring axial plane, the mirroring result of the first virtual element after flipping based on a mirroring axial plane can be automatically displayed, so that the structure presentation effect of the first virtual element is clearer and more visual, thereby improving the efficiency of designing the structure of the first virtual element by the user.

According to the method provided by this embodiment, the operation of copying the first virtual element can be realized in a plurality of manners, such as by dragging and by triggering the copying control, and may be superposed with a mirroring operation. Thus, the convenience of the editing operation can be improved. Virtual elements with specified quantity, position and orientation may be obtained through a simple operation. In the process of editing the first virtual element, the structural complexity and symmetry of the first virtual element are improved.

FIG. 17 is a structural block diagram of an apparatus for editing a virtual element in a virtual scene provided by one exemplary embodiment of the present disclosure. As shown in FIG. 17, the apparatus includes the following parts:
an object display module 1710 configured to display a first virtual element in a virtual scene;
a coordinate system display module 1720 configured to display a mirroring coordinate system in response to receiving a mirroring trigger operation for the first virtual element, the mirroring coordinate system including a plurality of mirroring coordinate axes, and the plurality of mirroring coordinate axes forming at least two mirroring axial planes which are configured for simulating a mirror surface to mirror the first virtual element; and
a mirroring result display module 1730 configured to display a mirroring result of the first virtual element based on a first mirroring axial plane in response to receiving a trigger operation for the first mirroring axial plane of the at least two mirroring axial planes.

In one exemplary embodiment, the coordinate system display module 1720 is further configured to display the mirroring coordinate system based on a first reference point in the virtual scene in response to receiving the mirroring trigger operation for the first virtual element, the first reference point being a location point determined based on the first virtual element, or the first reference point being a preset location point in the virtual scene.

In one exemplary embodiment, the coordinate system display module 1720 is further configured to: determine a center point corresponding to at least one first virtual element of a plurality of first virtual elements in response to receiving a mirroring trigger operation for the plurality of first virtual elements; and display the mirroring coordinate system based on the center point.

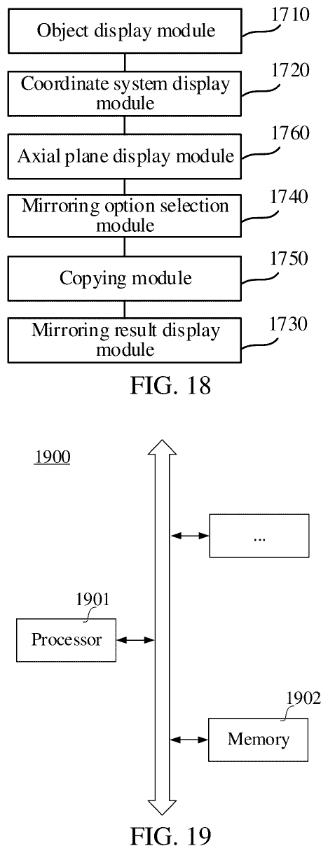

In one exemplary embodiment, prior to the mirroring result display module 1730, as shown in FIG. 18, the apparatus further includes:
a mirroring option selection module 1740 configured to: display a mirroring option including a center-based mirroring option and a flush mirroring option, where the center-based mirroring option represents that a center of the first virtual element is used as a center point of mirror flipping, and the flush mirroring option represents that a preset edge of the first virtual element is used as a central axis of mirror flipping; and receive a selection operation for any one of the center-based mirroring option and the flush mirroring option under the mirroring option.

In one exemplary embodiment, the mirroring result display module 1730 is further configured to display, in response to receiving the trigger operation for the first mirroring axial plane of the at least two mirroring axial planes and the center-based mirroring option being selected, the mirroring result of mirror flipping of the first virtual element with the center of the first virtual element as the center point of mirror flipping and the first mirroring axial plane as a flipping reference plane.

In one exemplary embodiment, the mirroring trigger operation is an operation for a plurality of first virtual elements.

The mirroring result display module 1730 is further configured to: display, in response to receiving the trigger operation for the first mirroring axial plane of the at least two mirroring axial planes and the center-based mirroring option being selected, the mirroring results of mirror flipping of the plurality of first virtual elements with a combined center of the plurality of first virtual elements as the center point of mirror flipping and the first mirroring axial plane as the flipping reference plane; or
display, in response to receiving the trigger operation for the first mirroring axial plane of the at least two mirroring axial planes and the center-based mirroring option being selected, the mirroring results of mirror flipping of the plurality of first virtual elements with a center of a specified virtual element of the plurality of first virtual elements as the center point of mirror flipping and the first mirroring axial plane as the flipping reference plane.

In one exemplary embodiment, the specified virtual element is a virtual element of the plurality of first virtual elements that meets a selection sequence condition which is configured for indicating an order requirement for the specified virtual element to be selected from the plurality of first virtual elements for mirror flipping.

In one exemplary embodiment, the mirroring result display module 1730 is further configured to display, in response to receiving the trigger operation for the first mirroring axial plane of the at least two mirroring axial planes and the flush mirroring option being selected, the mirroring result of mirror flipping of the first virtual element with a first edge of the first virtual element as the central axis of mirror flipping and the first mirroring axial plane as the flipping reference plane.

In one exemplary embodiment, the mirroring trigger operation is an operation for a plurality of first virtual elements.

The mirroring result display module 1730 is further configured to: display, in response to receiving the trigger operation for the first mirroring axial plane of the at least two mirroring axial planes and the flush mirroring option being selected, the mirroring results of mirror flipping of the plurality of first virtual elements with a combined edge of the plurality of first virtual elements as the central axis of mirror flipping and the first mirroring axial plane as the flipping reference plane; or
display, in response to receiving the trigger operation for the first mirroring axial plane of the at least two mirroring axial planes and the flush mirroring option being selected, the mirroring results of mirror flipping of the plurality of first virtual elements with a second edge of a specified virtual element of the plurality of first virtual elements as the central axis of mirror flipping and the first mirroring axial plane as the flipping reference plane.

In one exemplary embodiment, following the coordinate system display module 1720, the apparatus further includes:
a copying module 1750 configured to receive a copying trigger operation for the first virtual element.

The mirroring result display module 1730 is further configured to display, in response to receiving the trigger operation for the first mirroring axial plane of the at least two mirroring axial planes, a first copied virtual element corresponding to the first virtual element based on the copying trigger operation as the mirroring result of the first virtual element based on the first mirroring axial plane, where the first virtual element and the first copied virtual element are in a mirror relationship about the first mirroring axial plane.

In one exemplary embodiment, the copying module 1750 is further configured to copy the first virtual element in a dragging direction along a first mirroring coordinate axis and display a second copied virtual element in response to receiving a drag operation for the first mirroring coordinate axis of the plurality of mirroring coordinate axes.

The mirroring result display module 1730 is further configured to display mirroring results of both the first virtual element and the second copied virtual element based on the first mirroring axial plane in response to receiving the trigger operation for the first mirroring axial plane of the at least two mirroring axial planes.

In one exemplary embodiment, the first virtual element is attached with at least one second virtual element that follows the first virtual element.

The mirroring result display module 1730 is further configured to display mirroring results of both the first virtual element and the at least one second virtual element based on the first mirroring axial plane in response to receiving the trigger operation for the first mirroring axial plane of the at least two mirroring axial planes.

In one exemplary embodiment, the copying module 1750 is further configured to receive a copying trigger operation for the first virtual element.

The mirroring result display module 1730 is further configured to display mirroring results of both the first virtual element and the at least one second virtual element with the first mirroring axial plane as the flipping reference plane in response to receiving the trigger operation for the first mirroring axial plane of the at least two mirroring axial planes.

In one exemplary embodiment, the copying module 1750 is further configured to receive a copying trigger operation for the at least one second virtual element.

The mirroring result display module 1730 is further configured to display a plurality of third copied virtual elements corresponding to the at least one second virtual element in response to receiving the trigger operation for the first mirroring axial plane of the at least two mirroring axial planes, the plurality of third copied virtual elements being mirroring results of the at least one second virtual element with the first mirroring axial plane as the flipping reference plane, where the plurality of third copied virtual elements are attached to the first virtual element.

In one exemplary embodiment, following the coordinate system display module 1720, the mirroring result display module 1730 is further configured to: display sequential mirroring results of the first virtual element with a plurality of mirroring axial planes as the flipping reference planes in response to receiving a trigger operation for the plurality of mirroring axial planes of the at least two mirroring axial planes, where the mirror flipping process of the first virtual element conforms to a first selection sequence which is configured for indicating an order that the plurality of mirroring axial planes are selected; or, display simultaneous mirroring results of the first virtual element with the plurality of mirroring axial planes as the flipping reference planes in response to receiving the trigger operation for the plurality of mirroring axial planes of the at least two mirroring axial planes; or display mirroring results of the first virtual element with the plurality of mirroring axial planes as the flipping reference planes in response to receiving the trigger operation for the plurality of mirroring axial planes of the at least two mirroring axial planes, where in the mirroring process of the first virtual element, a flipping process based on an i+1^{th} mirroring axial plane is performed based on a flipping result for an i^{th} mirroring axial plane, i being a positive integer.

In one exemplary embodiment, following the coordinate system display module 1720, the apparatus further includes:
an axial plane display module 1760 configured to: display a representation feature option corresponding to the first mirroring axial plane in response to receiving a selection operation for the first mirroring axial plane of the at least two mirroring axial planes, the representation feature option being configured to adjust an appearance representation of the first mirroring axial plane; and
display the first mirroring axial plane with a first representation feature as the appearance representation in response to receiving a trigger operation for a first representation feature option.

The mirroring result display module 1730 is further configured to: display, in response to receiving the trigger operation for the first mirroring axial plane of the at least two mirroring axial planes, a mirroring result of the first virtual element with the first mirroring axial plane as the flipping reference plane and the first representation feature as the appearance representation. To sum up, according to the apparatus for editing a virtual element in a virtual scene provided by the present application, by receiving the mirroring trigger operation for the first virtual element (a UGC object), the mirroring coordinate system is displayed. A plurality of mirroring axial planes in the mirroring coordinate system can provide flipping reference planes for mirroring the first virtual element, thereby improving convenience when a user edits the first virtual element. By receiving the trigger operation for the mirroring axial plane, the mirroring result of the first virtual element after flipping based on a mirroring axial plane can be automatically displayed, so that the structure presentation effect of the first virtual element is clearer and more visual, thereby improving the efficiency of designing the structure of the first virtual element by the user.

FIG. 19 is a structural block diagram of a computer device 1900 according to an exemplary embodiment of the present disclosure. The computer device 1900 may be a smartphone, a tablet computer, a Moving Picture Experts Group (MPEG) audio layer III (MP3) player, an MPEG audio layer IV (MP4) player, a notebook computer, or a desktop computer. The computer device 1900 may be alternatively referred to by another name such as user equipment, a portable terminal, a laptop terminal, or a desktop terminal.

Typically, the computer device 1900 includes a processor 1901 and a memory 1902.

The processor 1901 may include one or more processing cores, for example, a 4-core processor or an 8-core processor. The processor 1901 may be implemented in at least one hardware form of a digital signal processor (DSP), a field-programmable gate array (FPGA), and a programmable logic array (PLA). The processor 1901 may alternatively include a main processor and a coprocessor. The main processor is a processor configured to process data in an awake state, and is also referred to as a central processing unit (CPU). The coprocessor is a low power consumption processor configured to process the data in a standby state. In some embodiments, the processor 1901 may be integrated with a graphics processing unit (GPU) configured to be responsible for rendering and drawing content that needs to be displayed on a display screen. In some embodiments, the processor 1901 may further include an Artificial Intelligence (AI) processor configured to process computing operations related to machine learning.

The memory 1902 may include one or more computer-readable storage media which may be non-transitory. The memory 1902 may alternatively include a high-speed random access memory and a non-volatile memory such as one or more magnetic disk storage devices and a flash storage device. In some embodiments, the non-transitory computer-readable storage medium in the memory 1902 is configured to store at least one instruction which is configured to be executed by the processor 1901 to implement the method for editing a virtual element in a virtual scene provided by the method embodiments of the present disclosure.

In some embodiments, the computer device 1900 further includes other components. The structure shown in FIG. 19 does not constitute a limitation to the computer device 1900, and the computer device may include more or fewer components than those shown in the figure, or some components may be combined, or a different arrangement of components may be adopted.

In one embodiment, the computer-readable storage medium may include a read-only memory (ROM), a random access memory (RAM), a solid state drive (SSD), an optical disc, or the like. The RAM may include a resistive random access memory (ReRAM) and a dynamic random access memory (DRAM). The sequence numbers of the foregoing embodiments of the present disclosure are merely for description purposes but do not indicate the preference of the embodiments.

An embodiment of the present disclosure further provides a computer device, including a processor and a memory, the memory having at least one instruction, at least one program, a code set, or an instruction set stored therein which is loaded and executed by the processor to implement the method for editing a virtual element in a virtual scene according to any one of the foregoing embodiments of the present disclosure.

An embodiment of the present disclosure further provides a computer-readable storage medium, having at least one instruction, at least one program, a code set, or an instruction set stored therein which is loaded and executed by the processor to implement the method for editing a virtual element in a virtual scene according to any one of the foregoing embodiments of the present disclosure.

An embodiment of the present disclosure further provides a computer program product or a computer program, including computer instructions stored in a computer-readable storage medium. A processor of a computer device reads the computer instructions from the computer-readable storage medium and executes the computer instructions to cause the computer device to perform the method for editing a virtual element in a virtual scene according to any one of the foregoing embodiments.

What is claimed is:

1. A method for editing a virtual element in a virtual scene, comprising:
displaying a first virtual element in a virtual scene;
displaying a mirroring coordinate system in response to receiving a mirroring trigger operation for the first virtual element, the mirroring coordinate system comprising a plurality of mirroring coordinate axes, and the plurality of mirroring coordinate axes forming at least two mirroring axial planes that are configured for simulating a mirror surface to mirror the first virtual element; and
displaying, in response to receiving a trigger operation for a first mirroring axial plane of the at least two mirroring axial planes, a mirroring result of the first virtual element based on the first mirroring axial plane.

2. The method according to claim 1, wherein displaying the mirroring coordinate system in response to receiving the mirroring trigger operation for the first virtual element comprises:
displaying, in response to receiving the mirroring trigger operation for the first virtual element, the mirroring coordinate system based on a first reference point in the virtual scene, the first reference point being a location point determined based on the first virtual element or a preset location point in the virtual scene.

3. The method according to claim 1, wherein displaying the mirroring coordinate system in response to receiving the mirroring trigger operation for the first virtual element comprises:
determining, in response to receiving a mirroring trigger operation for a plurality of first virtual elements, a center point corresponding to at least one first virtual element of the plurality of first virtual elements; and
displaying the mirroring coordinate system based on the center point.

4. The method according to claim 1, before displaying, in response to receiving the trigger operation for the first mirroring axial plane of the at least two mirroring axial planes, the mirroring result of the first virtual element based on the first mirroring axial plane, further comprising:
displaying a mirroring option, the mirroring option comprising a center-based mirroring option and a flush mirroring option, wherein the center-based mirroring option represents a center of the first virtual element being used as a center point of mirror flipping and the flush mirroring option represents a preset edge of the first virtual element being used as a central axis of mirror flipping; and
receiving a selection operation for any of the center-based mirroring option and the flush mirroring option in the mirroring option.

5. The method according to claim 4, wherein displaying, in response to receiving the trigger operation for the first mirroring axial plane of the at least two mirroring axial planes, the mirroring result of the first virtual element based on the first mirroring axial plane, comprises:
displaying, in response to receiving the trigger operation for the first mirroring axial plane of the at least two mirroring axial planes and the center-based mirroring option being selected, the mirroring result of mirror flipping of the first virtual element with the center of the first virtual element as the center point of mirror flipping and the first mirroring axial plane as a flipping reference plane.

6. The method according to claim 5, wherein:
the mirroring trigger operation is an operation for a plurality of first virtual elements; and
displaying, in response to receiving the trigger operation for the first mirroring axial plane of the at least two mirroring axial planes and the center-based mirroring option being selected, the mirroring result of mirror flipping of the first virtual element with the center of the first virtual element as the center point of mirror flipping and the first mirroring axial plane as the flipping reference plane comprises:
displaying, in response to receiving the trigger operation for the first mirroring axial plane of the at least two mirroring axial planes and the center-based mirroring option being selected, the mirroring results of mirror flipping of the plurality of first virtual elements with a combined center of the plurality of first virtual elements as the center point of mirror flipping and the first mirroring axial plane as the flipping reference plane; or
displaying, in response to receiving the trigger operation for the first mirroring axial plane of the at least two mirroring axial planes and the center-based mirroring option being selected, the mirroring results of mirror flipping of the plurality of first virtual elements with a center of a specified virtual element of the plurality of first virtual elements as the center point of mirror flipping and the first mirroring axial plane as the flipping reference plane.

7. The method according to claim 6, wherein the specified virtual element is a virtual element of the plurality of first virtual elements, the plurality of first virtual elements meeting a selection sequence condition, and wherein the selection sequence condition is configured for indicating an order requirement for the specified virtual element to be selected from the plurality of first virtual elements for mirror flipping.

8. The method according to claim 4, wherein displaying, in response to receiving the trigger operation for the first mirroring axial plane of the at least two mirroring axial planes, the mirroring result of the first virtual element based on the first mirroring axial plane, comprises:
displaying, in response to receiving the trigger operation for the first mirroring axial plane of the at least two mirroring axial planes and the flush mirroring option being selected, the mirroring result of mirror flipping of the first virtual element with a first edge of the first virtual element as the central axis of mirror flipping and the first mirroring axial plane as a flipping reference plane.

9. The method according to claim 8, wherein:
the mirroring trigger operation comprises an operation for a plurality of first virtual elements; and
displaying, in response to receiving the trigger operation for the first mirroring axial plane of the at least two mirroring axial planes and the flush mirroring option being selected, the mirroring result of mirror flipping of the first virtual element with the first edge of the first virtual element as the central axis of mirror flipping and the first mirroring axial plane as the flipping reference plane comprises:
displaying, in response to receiving the trigger operation for the first mirroring axial plane of the at least two mirroring axial planes and the flush mirroring option being selected, the mirroring results of mirror flipping of the plurality of first virtual elements with a combined edge of the plurality of first virtual elements as the central axis of mirror flipping and the first mirroring axial plane as the flipping reference plane; or
displaying, in response to receiving the trigger operation for the first mirroring axial plane of the at least two mirroring axial planes and the flush mirroring option being selected, the mirroring results of mirror flipping of the plurality of first virtual elements with a second edge of a specified virtual element of the plurality of first virtual elements as the central axis of mirror flipping and the first mirroring axial plane as the flipping reference plane.

10. The method according to claim 1, after displaying the mirroring coordinate system in response to receiving the mirroring trigger operation for the first virtual element, further comprising:
receiving a copying trigger operation for the first virtual element;
wherein displaying, in response to receiving the trigger operation for the first mirroring axial plane of the at least two mirroring axial planes, the mirroring result of the first virtual element based on the first mirroring axial plane comprises:
displaying, in response to receiving the trigger operation for the first mirroring axial plane of the at least two mirroring axial planes, a first copied virtual element corresponding to the first virtual element based on the copying trigger operation as the mirroring result of the first virtual element based on the first mirroring axial plane, wherein the first virtual element and the first copied virtual element are in a mirror relationship about the first mirroring axial plane.

11. The method according to claim 1, before displaying, in response to receiving the trigger operation for the first mirroring axial plane of the at least two mirroring axial planes, the mirroring result of the first virtual element based on the first mirroring axial plane, further comprising:
copying the first virtual element in a dragging direction along a first mirroring coordinate axis and displaying a second copied virtual element in response to receiving a drag operation for the first mirroring coordinate axis of the plurality of mirroring coordinate axes;
wherein displaying, in response to receiving the trigger operation for the first mirroring axial plane of the at least two mirroring axial planes, the mirroring result of the first virtual element based on the first mirroring axial plane comprises
displaying, in response to receiving the trigger operation for the first mirroring axial plane of the at least two mirroring axial planes, mirroring results of both the first virtual element and the second copied virtual element based on the first mirroring axial plane.

12. The method according to claim 1, wherein:
the first virtual element is attached with at least one second virtual element, the at least one second virtual element following the first virtual element; and
displaying, in response to receiving the trigger operation for the first mirroring axial plane of the at least two mirroring axial planes, the mirroring result of the first virtual element based on the first mirroring axial plane comprises:
displaying, in response to receiving the trigger operation for the first mirroring axial plane of the at least two mirroring axial planes, mirroring results of both the first virtual element and the at least one second virtual element based on the first mirroring axial plane.

13. The method according to claim 1, further comprising:
receiving a copying trigger operation for the first virtual element; and
displaying, in response to receiving the trigger operation for the first mirroring axial plane of the at least two mirroring axial planes, mirroring results of both the first virtual element and at least one second virtual element with the first mirroring axial plane as a flipping reference plane.

14. The method according to claim 1, further comprising:
receiving a copying trigger operation for at least one second virtual element; and
displaying, in response to receiving the trigger operation for the first mirroring axial plane of the at least two mirroring axial planes, a plurality of third copied virtual elements corresponding to the at least one second virtual element, the plurality of third copied virtual elements being mirroring results of the at least one second virtual element with the first mirroring axial plane as a flipping reference plane, wherein the plurality of third copied virtual elements are attached to the first virtual element.

15. The method according to claim 1, after displaying the mirroring coordinate system in response to receiving the mirroring trigger operation for the first virtual element, further comprising:
displaying sequential mirroring results of the first virtual element with a plurality of mirroring axial planes as flipping reference planes in response to receiving a trigger operation for the plurality of mirroring axial planes of the at least two mirroring axial planes, wherein a mirror flipping process of the first virtual element conforms to a first selection sequence, and the first selection sequence is configured for indicating an order that the plurality of mirroring axial planes are selected; or,
displaying simultaneous mirroring results of the first virtual element with the plurality of mirroring axial planes as the flipping reference planes in response to receiving the trigger operation for the plurality of mirroring axial planes of the at least two mirroring axial planes; or
displaying mirroring results of the first virtual element with the plurality of mirroring axial planes as the flipping reference planes in response to receiving the trigger operation for the plurality of mirroring axial planes of the at least two mirroring axial planes, wherein in a mirroring process of the first virtual element, a flipping process based on an i+1^{th} mirroring axial plane is performed based on a flipping result for an i^{th} mirroring axial plane, i being a positive integer.

16. The method according to claim 1, after displaying the mirroring coordinate system in response to receiving the mirroring trigger operation for the first virtual element, further comprising:
displaying a representation feature option corresponding to the first mirroring axial plane in response to receiving a selection operation for the first mirroring axial plane of the at least two mirroring axial planes, the representation feature option being configured to adjust an appearance representation of the first mirroring axial plane; and
displaying the first mirroring axial plane with a first representation feature as the appearance representation in response to receiving a trigger operation for a first representation feature option;
wherein displaying, in response to receiving the trigger operation for the first mirroring axial plane of the at least two mirroring axial planes, the mirroring result of the first virtual element based on the first mirroring axial plane comprises: displaying, in response to receiving the trigger operation for the first mirroring axial plane of the at least two mirroring axial planes, the mirroring result of the first virtual element with the first mirroring axial plane as a flipping reference plane and the first representation feature as the appearance representation.

17. An apparatus for editing a virtual element in a virtual scene, comprising a memory for storing instructions and a processor for executing the instructions, wherein the processor is configured to:
display a first virtual element in a virtual scene;
display a mirroring coordinate system in response to receiving a mirroring trigger operation for the first virtual element, the mirroring coordinate system comprising a plurality of mirroring coordinate axes, and the plurality of mirroring coordinate axes forming at least two mirroring axial planes, wherein the at least two mirroring axial planes are configured for simulating a mirror surface to mirror the first virtual element; and
display, in response to receiving a trigger operation for a first mirroring axial plane of the at least two mirroring axial planes, a mirroring result of the first virtual element based on the first mirroring axial plane.

18. The apparatus for editing a virtual element in a virtual scene of claim 17, wherein the processor, when being configured to display the mirroring coordinate system in response to receiving the mirroring trigger operation for the first virtual element, is further configured to:
display, in response to receiving the mirroring trigger operation for the first virtual element, the mirroring coordinate system based on a first reference point in the virtual scene, the first reference point being a location point determined based on the first virtual element or a preset location point in the virtual scene.

19. The apparatus for editing a virtual element in a virtual scene of claim 17, wherein the processor, when being configured to display the mirroring coordinate system in response to receiving the mirroring trigger operation for the first virtual element, is further configured to:
determine, in response to receiving a mirroring trigger operation for a plurality of first virtual elements, a center point corresponding to at least one first virtual element of the plurality of first virtual elements; and
display the mirroring coordinate system based on the center point.

20. A non-transitory computer readable medium storing a plurality of instructions, wherein the plurality of instructions, when executed by a processor, configure the processor to:
display a first virtual element in a virtual scene;
display a mirroring coordinate system in response to receiving a mirroring trigger operation for the first virtual element, the mirroring coordinate system comprising a plurality of mirroring coordinate axes, and the plurality of mirroring coordinate axes forming at least two mirroring axial planes, wherein the at least two mirroring axial planes are configured for simulating a mirror surface to mirror the first virtual element; and
display, in response to receiving a trigger operation for a first mirroring axial plane of the at least two mirroring axial planes, a mirroring result of the first virtual element based on the first mirroring axial plane.
